(19) United States
(12) Patent Application Publication
(10) Pub. No.: US 2010/0032594 A1
(43) Pub. Date: Feb. 11, 2010

(54) Freeze protection valve

(75) Inventors: Kevin Lamb, West Hartford, CT (US); Thomas Wisyanski, Bristol, CT (US); Kenneth Lionello, Waterbury, CT (US)

Correspondence Address: ALIX YALE & RISTAS LLP, 750 MAIN STREET, SUITE 1400, HARTFORD, CT, 06103, US

(73) Assignee: Rostra Vernatherm LLC, Bristol, CT (US)

(21) Appl. No.: 12/221,946

(22) Filed: Aug. 7, 2008

(51) Int. Cl. F16K 31/00

(52) U.S. Cl. 251/11

(57) ABSTRACT

A thermally actuated valve employs a plunger and bore valve configuration. A thermally expansible wax actuator has an axial length that changes in response to the temperature in a cavity of the valve. The plunger integrally extends from the actuator body and carries a seal. At temperatures above a predetermined set point, the actuator produces axial force sufficient to extend the length of the actuator against a return bias and project the plunger and seal into the bore, closing the valve. At temperatures below a second set point, the axial force of the actuator is less than the return bias and the plunger is withdrawn from the bore, opening the valve. The axial force generated by the actuator is variable and has a non-linear rate of change, providing a valve with a non-linear change flow rate with respect to temperature.

### BACKGROUND

1. Technical Field

The present disclosure relates to a thermally actuated control device, particularly of the type wherein a thermally responsive actuator controls the opening and closing of a fluid connection to prevent freezing in a water circulation system.

2. Background

The use of wax-filled actuators, otherwise referred to as wax motors, as thermally actuated control devices in fluid circulation systems is well known. Wax motors have been employed as actuators for valves employed to prevent fluid sources from freezing when the temperature drops. Such valves are designed to open or close in response to a predetermined change in temperature. Wax motors require no external power source, are reliable, extremely compact and powerful for their size.

Wax motors typically include a housing having a chamber filled with thermally responsive wax contained beneath a flexible diaphragm. The wax expands as temperature increases, exerting force on the diaphragm and on a reciprocating piston disposed on the other side of the diaphragm. Movement of the piston is controlled by a guide extending from the actuator housing. The wax motor is constructed such that known changes in temperature produce predetermined axial movement of the piston with respect to the housing.

Wax motor-actuated freeze protection valves are known where the piston is seated against a stop and the housing moves in response to changes in temperature. The housing carries a poppet that fits in a seat to control fluid flow. A return spring biases the housing and poppet away from the seat. At temperatures above freezing, the actuator exerts a force on the piston which moves the housing and poppet toward the seat against the bias of the return spring. At a predetermined temperature, typically above approximately 35° F., the force generated by the wax motor overcomes that of the return spring so that the poppet reaches the seat and the system is closed.

The intensity of the force generated by the wax motor changes with temperature, causing the actuator housing and poppet to move with respect to the valve seat at temperatures well above freezing. In freeze protection valves, the poppet must remain in the closed position over a wide range of greater than freezing temperatures while the actuator moves in response to temperature changes. Known valves of this type incorporate a poppet sub-assembly which accommodates actuator movement while maintaining the poppet in contact with the seat. The poppet sub-assembly includes a poppet retainer and poppet spring which allow the poppet to move independently of the actuator housing while the valve is closed. The retainer limits movement of the poppet toward the seat and the poppet spring defines the pressure exerted by the poppet on the seat. Thus, the poppet and seat remain stationary and sealed while the actuator housing moves in response to changes in temperature. The necessity for a poppet sub-assembly complicates both valve assembly and operation.

Fresh water solar collectors are used in temperate climates where freezing temperatures are exceptional. Freeze protection valves are employed in fresh water solar collectors to prevent freeze damage to the collectors. Conservation of fresh water resources is important wherever such systems are used, so limiting the amount of flow necessary to prevent freeze damage to a minimum is a priority.

Consequently, there exists a need for a wax motor-actuated freeze protection valve that employs a simplified mechanism to remain closed over a range of temperatures.

There is also a need for a simple and reliable freeze protection valve that accurately opens to prevent freezing, while minimizing leakage at near freezing temperatures to reduce waste of water.

### SUMMARY

The disclosure relates to a thermally actuated freeze protection valve of simplified construction and enhanced functionality. A housing defines an inlet, outlet and longitudinal cavity which houses a wax-filled actuator. A fluid flow channel connects the cavity and outlet. The actuator body includes a cup defining a wax reservoir and a guide for controlling axial movement of the piston. The actuator piston is seated against the housing, with the actuator body moving in the cavity in response to temperature changes. A return spring is arranged to bias the actuator body toward the piston.

Instead of the conventional poppet and seat valve construction, the disclosed freeze protection valve employs a plunger and bore valve configuration. In a disclosed embodiment, the plunger integrally extends from the actuator body and carries an O-ring seal seated in a circumferential groove. The disclosed plunger and bore are circular in cross-section, but are not limited to such a configuration. A circumferential wall projects into the cavity from the channel to define the bore. At above freezing temperatures, the actuator produces axial force on the piston sufficient to overcome the return spring and project the plunger and O-ring seal into the bore. The bore entrance and plunger include complementary beveled surfaces to facilitate alignment and entry of the plunger and seal into the bore. When the plunger is inside the bore, the O-ring seal is compressed between the inside surface of the bore and the plunger. The O-ring seal is compressed in a direction perpendicular to the direction of actuator movement. The sealing compression of the O-ring seal is independent of the force generated by the actuator.

The plunger and bore are configured with an axial length sufficient to accommodate movement of the actuator body at above freezing temperatures. This configuration allows the actuator, plunger and seal to move in response to changes in temperatures, while the valve remains closed. At a predetermined temperature, typically about 35° F., the wax in the actuator contracts, allowing the plunger and seal to axially disengage from the bore under the influence of the return spring, thus opening a fluid flow pathway between the inlet and the outlet. So long as temperatures remain below the predetermined value, the valve will remain open.

The disclosed valve configuration permits reciprocation of the plunger over a range of temperatures while the valve remains closed. The disclosed valve configuration eliminates the need for numerous additional mechanical elements found in known freeze protection valves.

### BRIEF DESCRIPTION OF THE DRAWINGS

FIG. 1 is a longitudinal sectional view through a first embodiment of a freeze protection valve according to aspects of the present disclosure;

FIG. 2 is an exploded preassembly sectional view of the freeze protection valve of FIG. 1;

FIG. 3 is an exterior side view of the freeze protection valve of FIGS. 1 and 2;

FIG. 4 is a schematic diagram of a pump system with the freeze protection valve of FIGS. 1-3 installed on the return side;

FIG. 5 is a longitudinal sectional view through the freeze protection valve of claims 1-3 illustrating the direction of actuation force F₁, return spring force F₂, actuation range of movement ΔD₁ and range of actuator movement at greater than freezing temperatures ΔD₂; and

FIG. 6 is a graphical presentation of actuator travel with respect to temperature change illustrating aspects of the disclosed freeze protection valve.

### DETAILED DESCRIPTION OF THE PREFERRED EMBODIMENTS

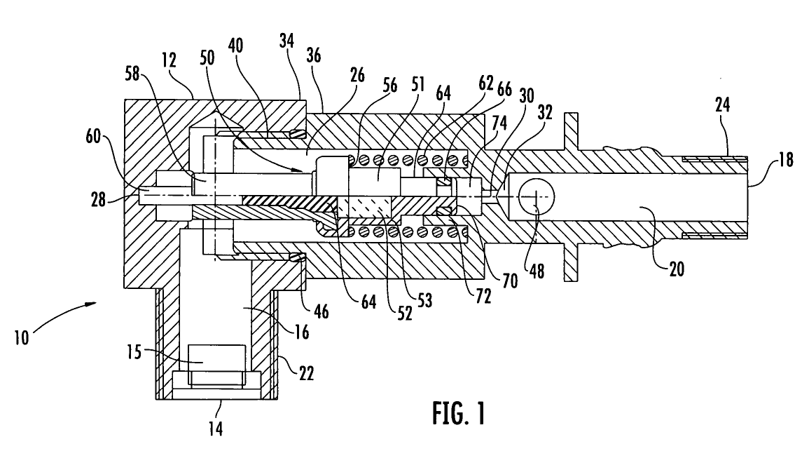

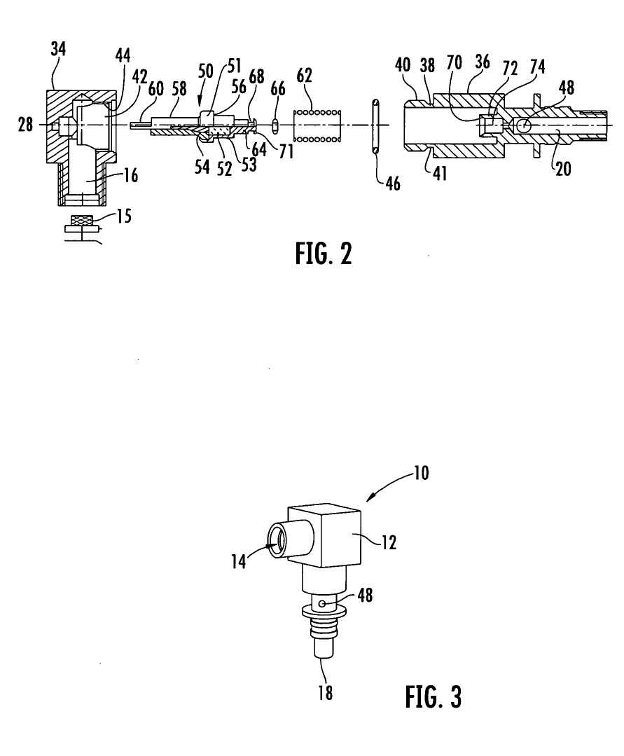

An embodiment of a freeze protection valve according to aspects of the present disclosure will now be described with reference to FIGS. 1-6. Referring to FIG. 1, the freeze protection valve 10 has a housing 12 which includes an inlet 14, an actuator cavity 26 and an outlet 18. FIG. 3 shows the outer surface and profile of the housing 12. In this embodiment, the housing 12 has a relatively L-shaped side profile, but is not limited to such a configuration. The housing 12 includes an inlet 14 which defines a fluid entry flow path 16 communicating with the actuator cavity 26 and an outlet 18 which defines a fluid discharge flow path 20. The fluid discharge flow path 20 may include an anti-siphon opening 48 to the ambient atmosphere to prevent reverse flow of water through the valve 10 as is known in the art. As depicted in FIGS. 1 and 2, the inlet 14 and outlet 18 may include threaded surfaces, 22 and 24, respectively to facilitate integration of the valve into fluid circulation systems. The outlet 18 is also equipped with barbs_and a stop_to facilitate connection of a flexible tube or hose instead of a threaded connection. The disclosed embodiment also includes a filter 15 positioned at the inlet 14 to prevent entry of particulates that may interfere with valve function.

As shown most clearly in FIG. 2, the disclosed freeze protection valve 10 features a housing 12 assembled from upper and lower portions, 34 and 36, respectively. The lower portion 36 has a projection 38 with a threaded outside surface 40. The upper portion 34 has an opening 42 and internal threaded surface 44 complementary to the projection 38 and external threaded surface 40 of the lower portion 36. The upper housing portion 34 is sealed to the lower housing portion 36 by an O-ring 46 arranged and compressed between radially opposed surfaces of the upper and lower portions 34, 36 as shown in FIG. 1. The upper and lower housing portions 34, 36 are molded from plastic formulated to withstand outdoor temperature extremes and long-term exposure to UV from sunlight. Suitable plastic formulations are commercially available. The connection between the housing upper and lower portions 34, 36 may alternatively be an adhesive bond, a sonic weld or other suitable method of joining.

As shown in FIG. 1, disposed within the cavity 26 is a wax-filled actuator 50 (which may alternatively be referred to as a “wax motor”) with a longitudinal axis that corresponds generally with the cavity axis 28. The actuator 50 includes a body 51 which defines a cup 53, and a guide 58 for controlling axial movement of a piston 60 relative to the body 51. The actuator cup 53 contains a reservoir of wax material 52 which expands and contracts in response to temperature changes in a known manner. A flexible diaphragm 54 is positioned within the actuator body 51 to retain the wax 52 within the cup 53 and transmit force from the wax 52 to the piston 60, which results in axial movement of the piston 60 relative to the actuator body 51. In the disclosed freeze valve, the guide 58 and cup 53 are constructed of brass, while the piston is a selected plastic material such as Delryn. The brass and plastic materials are selected for their resistance to corrosion generally associated with fresh water.

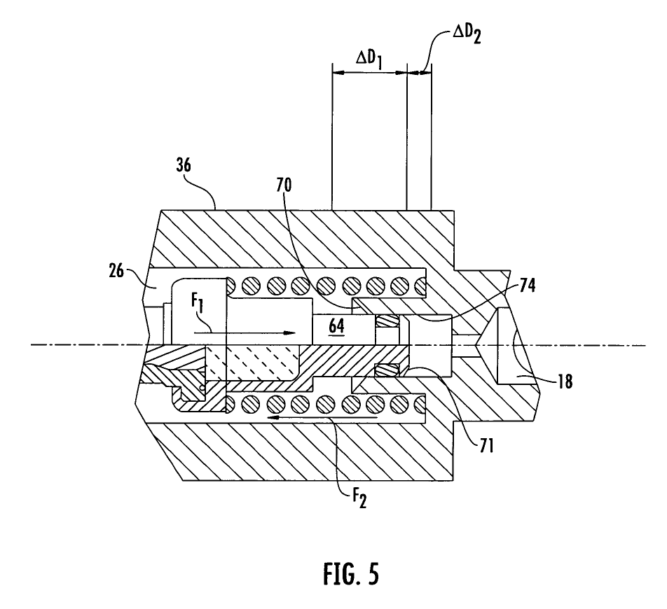

The particular actuator 50 depicted in FIGS. 1 and 2 has a shoulder 56 projecting outwardly from the body 51. A return member 62 is engaged with the actuator body 51 at the shoulder 56 and biases the body 51 away from the channel 30. Here, the return member 62 is a coil spring. The spring's bias force is designated as F₂ in FIG. 5. The return spring force F₂ is opposed by force F₁ generated by the wax 52 on the piston 60 seated against the housing upper portion 34 as shown in FIG. 1. As is known in the art, thermally responsive wax can be formulated to expand to generate the actuation force F₁ over a broad range of temperatures.

In the disclosed embodiment, the plunger 64 integrally extends from the actuator body 51 and carries an O-ring seal 66 seated in a circumferential groove 68. Other arrangements, such as a mechanical connection between the actuator body 51 and the plunger 64 are compatible with the disclosed freeze protection valve. A circumferential wall 72 defining a bore 74 extends axially into the cavity 26 from the fluid flow channel 30. In this embodiment, the bore 74, plunger 64 and seal 66 are configured with circular cross sections, though they are not limited to such a configuration. The plunger 64 and seal 66 are connected to the actuator body 51 for axial movement therewith.

In the disclosed freeze protection valve 10, expansion of the thermally responsive wax 52 within the actuator cup 53 due to a temperature increase produces an axial force F₁ upon the body 51 that is sufficient to overcome the opposite axial force F₂ of the return member 62 and project the plunger 64 and O-ring seal 66 toward the fluid flow channel 30. At a predetermined temperature, generally above 35° F, the force F₁ produced by the wax 52 expansion is sufficient to project the plunger 64 and O-ring seal 66 into the bore 74. As seen most clearly in FIG. 2, the bore entrance and the end of the plunger have complementary beveled edges 70, 71 to facilitate alignment and entry of the plunger 64 and seal 66 into the bore 74. When inside the bore 74, the O-ring seal 66 is compressed between the inside surface of the bore 74 and the plunger 64. The O-ring seal 66 is compressed in a direction generally perpendicular to the direction of actuator movement, thus closing the fluid flow path between the inlet 14 and outlet 18 through cavity 26. The sealing compression of the O-ring seal 66 is independent of the forces F₁ and F₂ generated by the actuator 50 and the return member 62. Conversely, the thermally responsive wax 52 contracts with a falling temperature below a predetermined value and allows the return member 62 to move the plunger 64 and O-ring seal 66 away from the channel 30. At a predetermined temperature, the force F₂ exerted by the return member 62 on the actuator body 51 is greater than the actuation force F₁ generated by the actuator 50 so the plunger 64 and O-ring seal 66 are withdrawn from the bore 74, opening the valve so water flows between the inlet 14 and outlet 18 through the cavity 26. Although an O-ring seal is illustrated, other sealing configurations between the plunger 64 and bore 74 are compatible with the disclosed freeze protection valve 10.

The disclosed freeze protection valve 10 will spend most of its working life in the closed position, with the plunger 64 and seal 66 received in the bore 74 to prevent fluid flow through the valve. The actuator contains a wax material 52 which changes state from a liquid (contracted) to a crystalline solid (expanded) in response to a pre-determined reduction in temperature. The wax 52 goes through a reverse transition from crystalline solid (contracted) to liquid (expanded) in response to a pre-determined increase in temperature. The disclosed freeze protection valve is constructed to open as temperatures fall through the range from about 36° F. to 32° F., with the wax changing state from liquid (expanded) to solid (contracted). In its solid state, the wax 52 occupies less space within the cup 53, reducing pressure on the piston 60, which allows the plunger 64 and seal 66 to withdraw from the bore under the influence of the return spring 62. The disclosed actuator 50 is calibrated in a manner known in the art by altering the volume of the cup to establish a actuator length at a known temperature so that the plunger 64 and seal 66 are accurately positioned relative to the bore 74. The actuator is calibrated so that the seal 66 leaves the bore at approximately 35° F., allowing fluid to begin flowing through the valve.

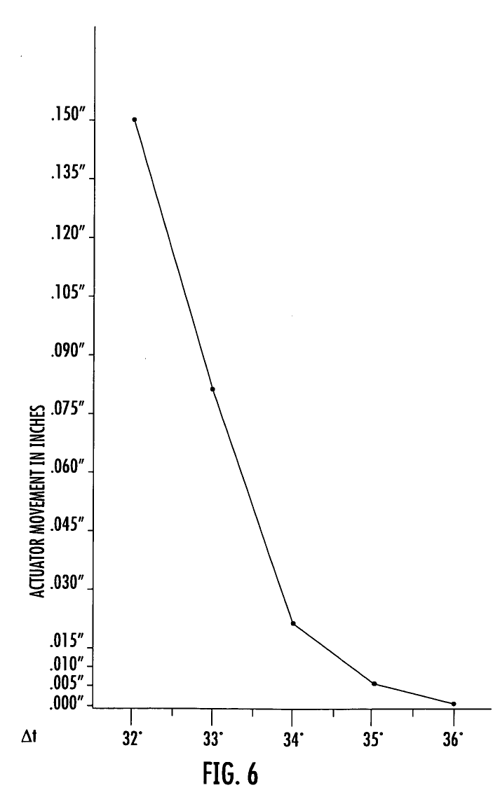

The disclosed exemplary freeze protection valve 10 is configured to produce approximately 0.150″ movement ΔD₁ of the plunger 64 and seal 66 with respect to the bore 74 between 36° F. and 32° F. In the disclosed freeze protection valve, the wax material 52 is formulated to begin its transition from liquid (expanded) to solid (contracted) when the temperature of fluid in the cavity 26 surrounding the actuator 50 is approximately 36° F. and complete that transition when the temperature in the cavity is approximately 32° F. The wax material 52 is formulated so that a majority of the transition and the associated movement occurs between 34° F. and 32° F. An exemplary embodiment of the disclosed freeze protection valve divides actuator movement as follows: 5% of actuator movement occurs between 36° F. and 35° F., 10% of actuator movement occurs between 35° F. and 34° F., 40% of actuator movement between 34° F. and 33° F. and 45% of actuator movement between 33° F. and 32° F. FIG. 6 is a graph showing actuator movement with respect to temperature for the disclosed exemplary embodiment of the freeze protection valve 10. This valve configuration regulates the flow of water through the valve, with maximum flow occurring at temperatures presenting the greatest risk of freeze damage. The axial force generated by the actuator, the axial length of the actuator (movement of the plunger with respect to the bore) and the flow rate through the valve are all non-linear. The valve is configured to produce the greatest flow rate and greatest rate of increase in the flow rate as temperatures decline toward 32° F.

At temperatures between 35° F. and about 150° F. the wax 52 remains in its liquid (expanded) state, pushing the piston 60 away from the wax 52 to maintain the valve in the closed position, with the plunger 64 and seal 66 received in the bore 74. Thermal expansion of the wax and actuator materials at temperatures above 35° F. produces approximately 0.001″ of actuator movement for each 1° F. to 2° F. increase in temperature. The bore 74 and plunger 64 of the disclosed freeze protection valve 10 are configured to accommodate at least approximately 0.050″ of movement ΔD₂ of the plunger 64 and seal 66 inside the bore 74 while the valve remains closed. This configuration prevents accumulation of force within the valve due to thermal expansion at high temperatures. This movement is illustrated as ΔD₂ in FIG. 5. The seal 66 is laterally compressed between the plunger 64 and the bore 74 in a direction perpendicular to actuator movement. Sealing engagement between the plunger 64 and the bore 74 is independent of temperature while the valve is in the closed position.

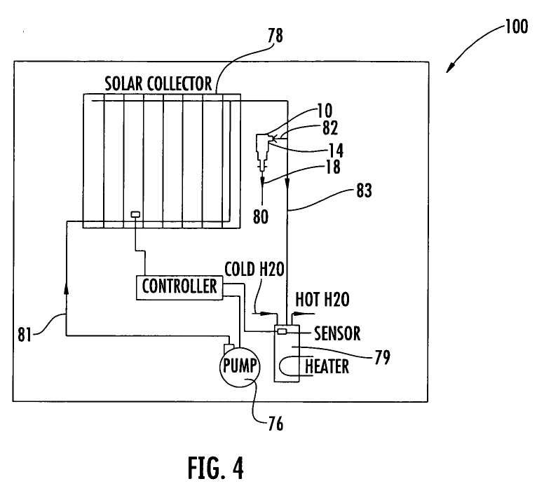

FIG. 4 illustrates a typical installed configuration for a freeze protection valve 10. The freeze protection valve is installed in a pump fed fresh water solar hot water system 100 as known in the art. As can be seen, the system 100 includes a pump 76, solar collectors 78 and storage tank 79 connected via water lines 81 and 83. The freeze protection valve 10 is arranged in the system 100 to allow near freezing water to drain from the solar collectors 78 and be replaced by warmer water to prevent freeze damage. The freeze protection valve 10 is installed on the exit side of the solar collectors 78 in a location where it is exposed to the coldest ambient temperature. For optimal performance, the valve 10 is installed in an upright position.

In general and as described above, the freeze protection valve 10 opens upon a drop in temperature to allow water that is near freezing to be discharged 80 and replaced with warmer water 82. The coldest temperatures typically occur in the early morning hours before dawn. The water circulated to replace the discharged cold water is typically coming from within the building to which the solar hot water system is attached and is therefore significantly warmer than the outside temperature. The warm water expands the wax in the actuator, closing the freeze protection valve as described above. The cooling, opening, warming, closing cycle repeats until the ambient temperature exceeds approximately 35° F., above which temperature the freeze protection valve remains closed.

As best illustrated in FIG. 5, the actuator body 51, plunger 64 and seal 66 move through a distance ΔD₁ with respect to the bore 74. As described above, the valve 10 remains closed over a range of temperatures above about 35° F. The plunger 64 and seal are configured to accommodate thermal expansion of the wax and actuator components, which produce additional movement ΔD₂ of the actuator body 51, plunger 64 and seal 66 with respect to the bore 74. The disclosed configuration of the bore 74 and its interaction with the plunger 64 and O-ring seal 66 eliminate the need for a poppet sub-assembly while retaining the functionality of the sub-assembly.

While a preferred embodiment of the disclosed freeze protection valve has been set forth for purposes of illustration, the foregoing description should not be deemed a limitation of the invention herein. Accordingly, various modifications, adaptations and alternatives may occur to one skilled in the art without departing from the spirit and the scope of the present invention.

1. A thermally actuated valve comprising:
a housing defining an inlet, an outlet, and a cavity having a longitudinal axis disposed between and in fluid communication with said inlet and outlet;
an actuator disposed in said cavity and having an axial length responsive to changes in temperature in said cavity, said actuator generating a variable axial force F₁ acting to increase the axial length of said actuator in response to an increase in temperature from a first temperature T₁ to a second temperature T₂, said variable axial force F₁ being greatest at temperatures above T₂ and least at temperatures below T₁;
a plunger extending axially from said actuator for movement therewith;
a bore communicating with said cavity and said outlet, said bore aligned with said plunger and configured to receive said plunger;
a seal on one of said plunger or said bore, said seal arranged to engage the other of said plunger or bore to prevent fluid communication between said cavity and said outlet when said plunger is received in said bore; and
a return member engaged with said actuator to bias the actuator and plunger away from said bore with a bias force F₂ opposed to said variable axial force F₁,
wherein said variable axial force F₁ overcomes said bias force F₂ to extend said actuator to a first axial length at temperatures above T₂ to project said plunger into said bore, said bias force F₂ acting to reduce the axial length of actuator as said variable axial force F₁ declines in response to temperatures below T₂ to a second axial length at temperature T₁, said second axial length being insufficient to project said plunger into said bore, resulting in fluid communication between said inlet and said outlet, said fluid communication having a flow rate which varies with the axial length of said actuator.

2. The thermally actuated valve of claim 1, wherein a rate of change of said variable axial force F₁ between temperatures T₁ and T₂ is non-linear.

3. The thermally actuated valve of claim 1, wherein a rate of change of said variable axial force F₁ is non-linear and said rate of change is greater at T₁ than T₂.

4. The thermally actuated valve of claim 1, wherein said temperature T₂ is approximately 4° F. greater than T₁ and a rate of change of said variable axial force F₁ per degree change in temperature increases as said temperature declines from T₂ toward T₁.

5. The thermally actuated valve of claim 1, wherein a rate of change of said variable axial force F₁ per unit change of temperature increases as said temperature declines from T₂ toward T₁, resulting in a non-linear rate of change in the axial length of said actuator.

6. The thermally actuated valve of claim 1, wherein a rate of change of said axial length of said actuator per unit change of temperature increases as said temperature declines from T₂ toward T₁.

7. The thermally actuated valve of claim 1, wherein T₂ is approximately 4° F. greater than T₁ and a rate of change of the axial length of said actuator per degree change in temperature increases as said temperature declines from T₂ toward T₁ producing a rate of change of said flow rate through said valve that is non-linear and said rate of change of said flow rate is greatest as said temperature approaches T₁.

8. The thermally actuated valve of claim 1, wherein T₂ is approximately 36° F. and T₁ is approximately 32° F. and a rate of change of the axial length of said actuator per degree change in temperature increases as said temperature declines from 36° F. toward 32° F. producing a rate of change of said flow rate through said valve that is non-linear and said rate of change of said flow rate is greatest as said temperature approaches 32° F.

9. The thermally actuated valve of claim 1, wherein said variable axial force F₁ is dependent upon the volume of a thermally expansible wax material contained in said actuator, a rate of change in the volume of said wax material per unit change in temperature increasing as temperatures fall from T₂ toward T₁ and declining as temperatures increase from T₁ toward T₂.

10. The thermally actuated valve of claim 1, wherein said actuator comprises a body containing a thermally expansible wax material and a piston moveable with respect to the body, the position of said piston relative to the body dependent upon a volume occupied by said wax material, said piston is seated against said valve housing and said body is moveable in said cavity in response to movement of said piston relative to said body.

11. The thermally actuated valve of claim 10, wherein said body further comprises an outwardly projecting circumferential shoulder and said return member is a coil spring that is engaged between said actuator body and said housing.

12. The thermally actuated valve of claim 1, wherein said seal is compressed between said bore and said plunger in a direction that is perpendicular to a direction of plunger movement when said plunger is positioned within said bore.

13. The thermally actuated valve of claim 1, wherein said seal is compressed between said plunger and said bore and compression of said seal when said plunger is received in said bore is independent of said variable axial force F₁.

14. The thermally actuated valve of claim 1, wherein said plunger and bore are configured to accommodate axial movement of said plunger in said bore in response to changes in temperature above T₂.

15. The thermally actuated valve of claim 1, wherein said bore includes an entrance and said plunger includes a forward end, said entrance and forward end having complementary configurations to facilitate alignment of said plunger with said bore and entry of said plunger into said bore.

16. The thermally actuated valve of claim 1, wherein said seal is a polymeric O-ring compressed between said plunger and said bore.

17. The thermally actuated valve of claim 1, wherein said housing comprises an upper portion rigidly attached to a lower portion, each of said upper and lower portions defining a portion of said cavity.

18. The thermally actuated valve of claim 1, wherein said input is connected to a liquid source and T₁ is the freezing temperature of said liquid.
